(19) United States
(12) Patent Application Publication
(10) Pub. No.: US 2003/0033722 A1
(43) Pub. Date: Feb. 20, 2003

(54) Telescopic leveling instrument

(76) Inventor: Anthony D. Lanham, Apopka, FL (US)

Correspondence Address: Edward M. Livingston, Esq., 628 Ellen Dr., P.O. Box 1599, Winter Park, FL, 32790, US

(21) Appl. No.: 09/924,192

(22) Filed: Aug. 8, 2001

(51) Int. Cl. G01C 9/00

(52) U.S. Cl. 33/374

(57) ABSTRACT

A telescopic leveling instrument has a small and light-weight bubble-level block (1) with orthogonal walls that include a rectangular first end (3) and a rectangular second end (4) from which telescopic markers are extended. The telescopic markers can include circular telescopic tubes (2), square telescopic tubes (11) or rectangular telescopic tubes (12). The bubble-level block is articulated to be finger-held with a first hand of a user for positioning it against an object while with a second hand, the user is utilizing the telescopic markers for measuring and marking a desired position selectively in relationship to the object against which the bubble-level block is being held. Attachable to extendable ends of the telescopic markers can be a selection of marking aids (17, 18, 19, 20, 21, 22, 23, 24). Preferably, the telescopic markers are ruled with distance indicia for fine measurement. The telescopic markers can be attached removably to the rectangular ends for horizontal measurement and levelness marking in a single direction or in oppositely disposed directions from the bubble-level block. Optionally, one or more of the telescopic markers can be attached removably to a bottom of the bubble-level block for measuring and marking verticality, squareness and vertical distances.

### BACKGROUND OF THE INVENTION

This invention relates to levels and leveling instruments for level hanging, positioning and orientation of pictures, shelves, tables, platforms and separated items.

Levels and leveling instruments have been known and adapted progressively since antiquity. None are known, however to be a conveniently hand-held leveling square with telescopic measuring and marking extensions from sides in a manner taught by this invention.

Examples of most-closely related known but different devices are described in the following patent documents:

| U.S. Pat. No. | Inventor | Issue Date |
|---|---|---|
| 4,429,466 | Leonard | Feb. 07, 1984 |
| 5,103,573 | Ehling, et al. | Apr. 14, 1992 |
| 5,451,027 | McHenry | Sept. 19, 1995 |
| 4,443,949 | Newton | Apr. 24, 1984 |
| 6,032,378 | Null | Mar. 07, 2000 |
| 6,029,362 | Miodragovic | Feb. 29, 2000 |
| 5,509,213 | Kelly, et al. | Apr. 23, 1996 |
| 4,241,510 | Radecki | Dec. 30, 1980 |

Of all known prior art, the Leonard patent appears to be most nearly like and yet patentably different from this invention. The Leonard patent is limited to a layout combination tool having an elongated frame along which rectangular template pieces are positioned in indentations. A pair of two of the rectangular template pieces are oppositely disposed along the length of the elongate frame and the other of the three is attached to a bottom central portion of the elongate frame. The Leonard patent shows a telescopic device that is referred to as a measuring means for positioning a layout apparatus that does not anticipate a telescopic marker on a leveling instrument as taught by Applicant.

### SUMMARY OF THE INVENTION

Objects of patentable novelty and utility taught by this invention are to provide a telescopic leveling instrument which:

can be hand-held conveniently against a surface or against corner walls while being used for bubble-leveling and for marking level distances; and

has versatility for arranging picture-hanging, leveling shelves, leveling platforms and measuring variances from level with a reference surface.

This invention accomplishes these and other objectives with a telescopic leveling instrument having a small and light-weight bubble-level block with orthogonal walls and rectangular ends. Telescopic markers are extended from the rectangular ends. The bubble-level block is articulated to be finger-held with a first hand of a user for positioning it against a surface or corner of walls while with a second hand, the user is extending the telescopic markers, measuring and marking a desired position in relationship to the surface or corner of walls against which the bubble-level block is being held. Extendable ends of the telescopic markers have a selection of marking aids which can be attached and can include a marking holder, a marking-point holder, a marking-medium holder, a marking ring, a marking point, a marking edge and a marking indentation. The telescopic markers can be attached removably to the rectangular ends for horizontal measurement and levelness marking in a single direction or in oppositely disposed directions from the bubble-level block. Optionally, one or more of the telescopic markers can be attached removably to a bottom of the bubble-level block for measuring and marking verticality and vertical distances.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a side view of an embodiment of the telescopic leveling instrument having a plurality of telescopic markers that are circular telescopic tubes on ends of a bubble-level block and having horizontal axes and with marker rings attached;

FIG. 2 is a top view of the FIG. 1 embodiment;

FIG. 3 is a bottom view of the FIG. 1 embodiment;

FIG. 4 is a partially cutaway side view of the FIG. 1 embodiment having an optional telescopic marker extended vertically downward from a bottom of the bubble-level block;

FIG. 5 is a partially cutaway end view of the FIG. 4 illustration;

FIG. 6 is bottom view of an embodiment of the telescopic leveling instrument having a plurality of telescopic markers that are square telescopic tubes on ends of the bubble-level block and having horizontal axes with marker rings attached;

FIG. 7 is a partially cutaway side view of the FIG. 6 embodiment having an optional telescopic marker extended vertically downward from the bottom of the bubble-level block;

FIG. 8 is a partially cutaway end view of the FIG. 7 illustration;

FIG. 9 is bottom view of an embodiment of the telescopic leveling instrument having a plurality of telescopic markers that are rectangular telescopic tubes oriented vertically on ends of the bubble-level block and having horizontal axes with marker rings attached;

FIG. 10 is a partially cutaway side view of the FIG. 9 embodiment having an optional telescopic marker extended vertically downward from the bottom of the bubble-level block;

FIG. 11 is a partially cutaway end view of the FIG. 10 illustration;

FIG. 12 is a partially cutaway side view of a plurality of telescopic markers that are circular telescopic tubes ruled with distance indicia and extended from the bubble-level block that is ruled with distance indicia;

FIG. 13 is a partially cutaway side view of a plurality of telescopic markers that are square telescopic tubes ruled with distance indicia and extended from the bubble-level block that is ruled with distance indicia;

FIG. 14 is a partially cutaway side view of a plurality of telescopic markers that are vertically oriented rectangular telescopic tubes ruled with distance indicia and extended from the bubble-level block that is ruled with distance indicia;

FIG. 15 is a side view of the bubble-level block having side positioning channels;

FIG. 16 is a bottom view of the bubble-level block having bottom positioning channels;

FIG. 17 is a partially cutaway end view of the bubble-level block with telescopic markers that are circular telescopic tubes and having side positioning channels and bottom positioning channels;

FIG. 18 is a partially cutaway end view of the bubble-level block with telescopic markers that are square telescopic tubes and having side positioning channels and bottom positioning channels;

FIG. 19 is a partially cutaway end view of the bubble-level block with telescopic markers that are vertically oriented rectangular telescopic tubes and having side positioning channels and bottom positioning channels;

FIG. 20 is a fragmentary side view of a marking aid that is a point holder that holds a selection of marker points that includes a stylus and a pencil lead;

FIG. 21 is a fragmentary side view of a marking aid that is a liquid-dispenser holder that holds a selection of liquid dispensers that includes a ballpoint pen;

FIG. 22 is a fragmentary side view of a marking aid that is a powder holder that holds a porous dispenser of powder;

FIG. 23 is a fragmentary side view of a marking aid that is a marking point attached directly to an extendable end of the telescopic marker;

FIG. 24 is a fragmentary side view of a marking aid that is a predeterminedly short straight edge on a block having predetermined size relationship to the bubble-level block;

FIG. 25 is an end view of the FIG. 24 illustration; and

FIG. 26 is a fragmentary side view of a marking aid that includes a V-shaped marking indentation.

### DESCRIPTION OF PREFERRED EMBODIMENT

Listed numerically below with reference to the drawings are terms used to describe features of this invention. These terms and numbers assigned to them designate the same features throughout this description.

1. Bubble-level block

2. Circular telescopic tubes

3. First end

4. Second end

5. Bottom

6. Level-bubble tube

7. Leveling bubble

8. Top

9. First side

10. Second side

11. Square telescopic tubes

12. Rectangular telescopic tubes

13. Distance indicia

14. Side positioning channels

15. Bottom positioning channel

16. Cross positioning channels

17. Marker ring

18. Point holder

19. Liquid-dispenser holder

20. Powder holder

21. Marking point

22. Straight-edge block

23. V-shaped indentation

24. Straight edge

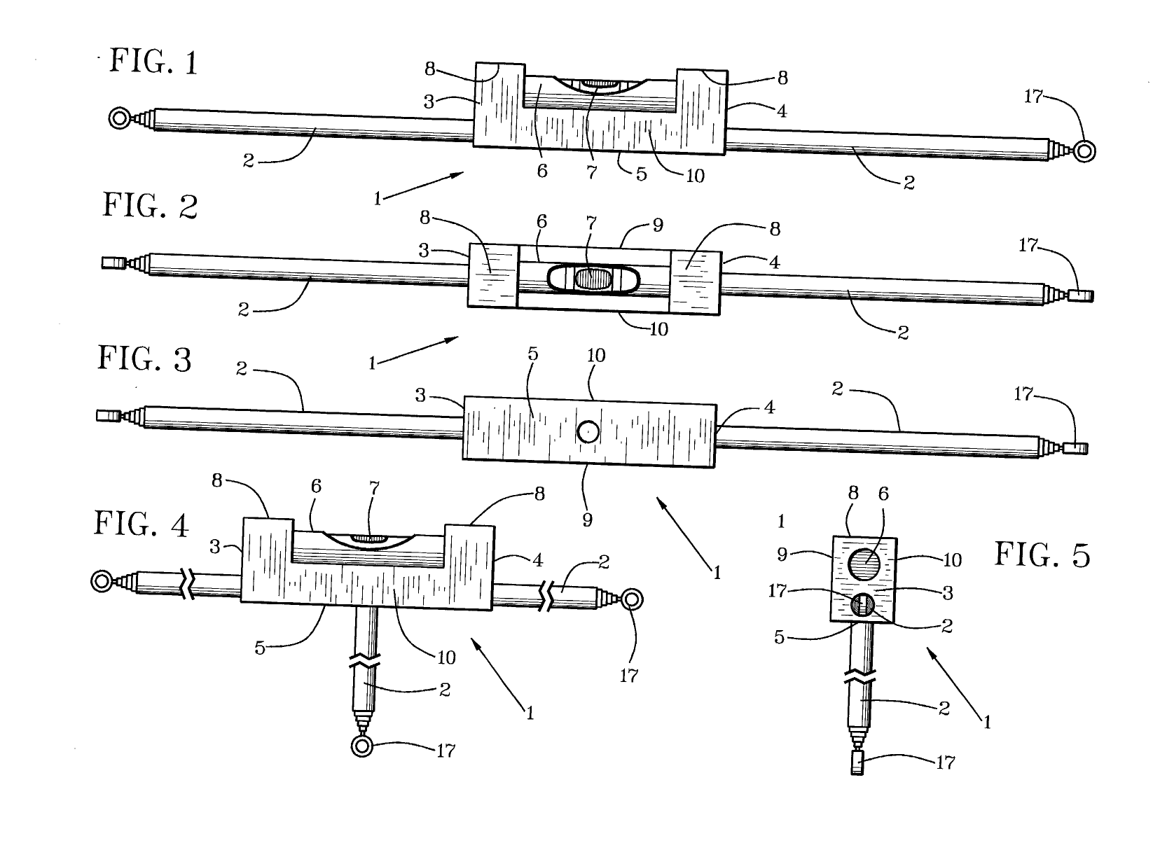

Referring to FIGS. 1-5, the telescopic leveling instrument has a bubble-level block 1 with orthogonal walls and one or more telescopic markers that can include circular telescopic tubes 2 extended horizontally from at least one of the orthogonal walls that is vertical. The bubble-level block 1 is predeterminedly small, light-weight and articulated to be hand-held with a first hand of a user for positioning it against an object while with a second hand of the user, the telescopic markers that can include the circular telescopic tubes 2 are employed to measure and to mark selectively in relationship to the object.

The telescopic markers are extended from oppositely disposed vertical walls which preferably are a first end 3 and a second end 4 that are rectangular. The telescopic markers that include the circular telescopic tubes 2 have axes that are collinear and defined as being horizontal axes, although intended to be positioned and oriented by movement of the bubble-level block 1 as desired for marking selectively.

Optionally, a telescopic marker that includes the circular telescopic tubes 2 can be extended vertically from a bottom 5 and have a vertical axis that is orthogonal to the horizontal axes of the telescopic markers that are extended from the two oppositely disposed vertical walls.

A level-bubble tube 6 is situated on the bubble-level block 1 with a leveling bubble 7 exposed for visibility from a top 8 and at least partially from a first side 9 and from a second side 10 of the bubble-level block 1.

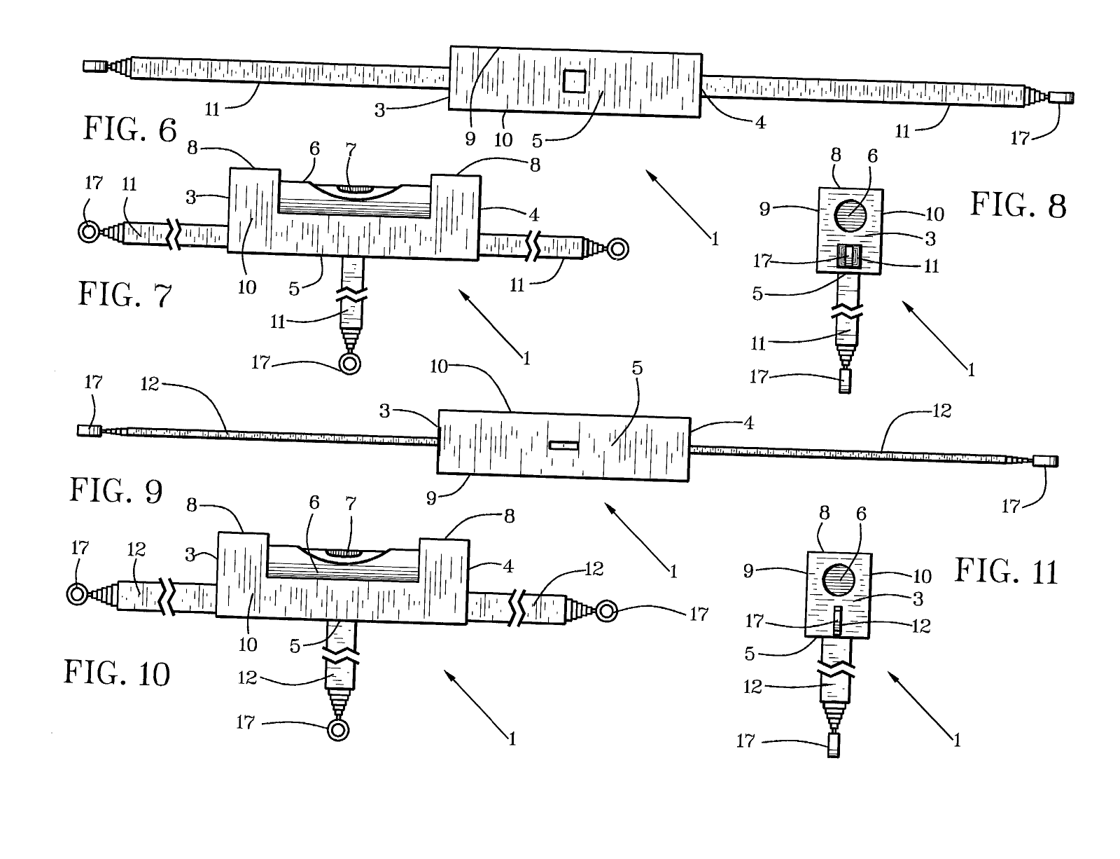

Referring to FIGS. 1-11, the telescopic markers are articulated to provide rigidity to maintain an extended-mode horizontality to a horizontal-surface wall of the bottom 5. Optionally, the telescopic markers are articulated to provide horizontal-bend resilience for touch marking with marking aids on extendable ends. Square telescopic tubes 11 shown in FIGS. 6-8 and rectangular telescopic tubes 12 shown in FIGS. 9-11 provide more reliable positioning per size and weight than the circular telescopic tubes 2. The rectangular telescopic tubes 12 are particularly effective for touch marking and flip marking.

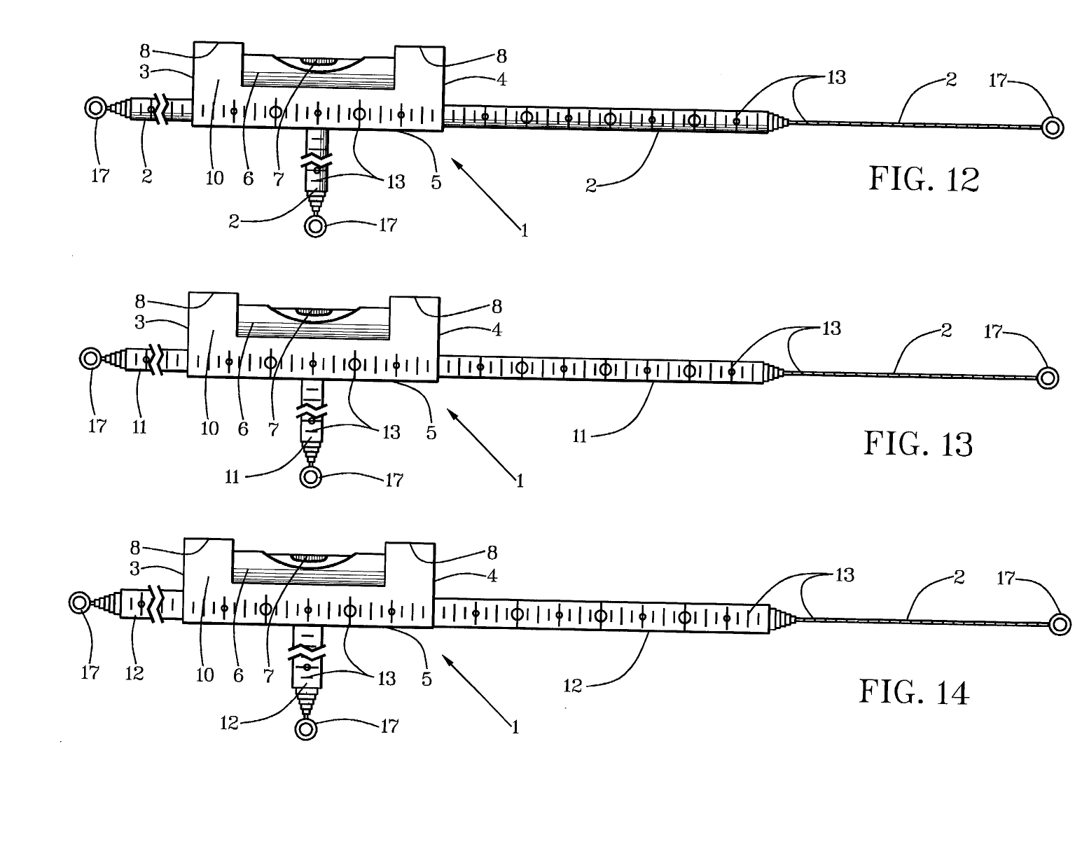

Referring to FIGS. 12-14, distance indicia 13 can be included on the bubble-level block 1, on the circular telescopic tubes 2, on the square telescopic tubes 11 and on the rectangular telescopic tubes 12. The distance indicia 13 can be in inch gradations as shown or in metric gradations. Numbers for the distance indicia 13, however, occur telescopically reverse from numerical order for numbering the gradations. Also opposite from numerical order, inside telescopic members extend before outside telescopic members as a result of lower frictional resistance of less surface area. Nevertheless, the gradations for the distance indicia 13, are very helpful and can be as fine as desired for final precision measurement in combination with a separate measuring instrument for determining total distances.

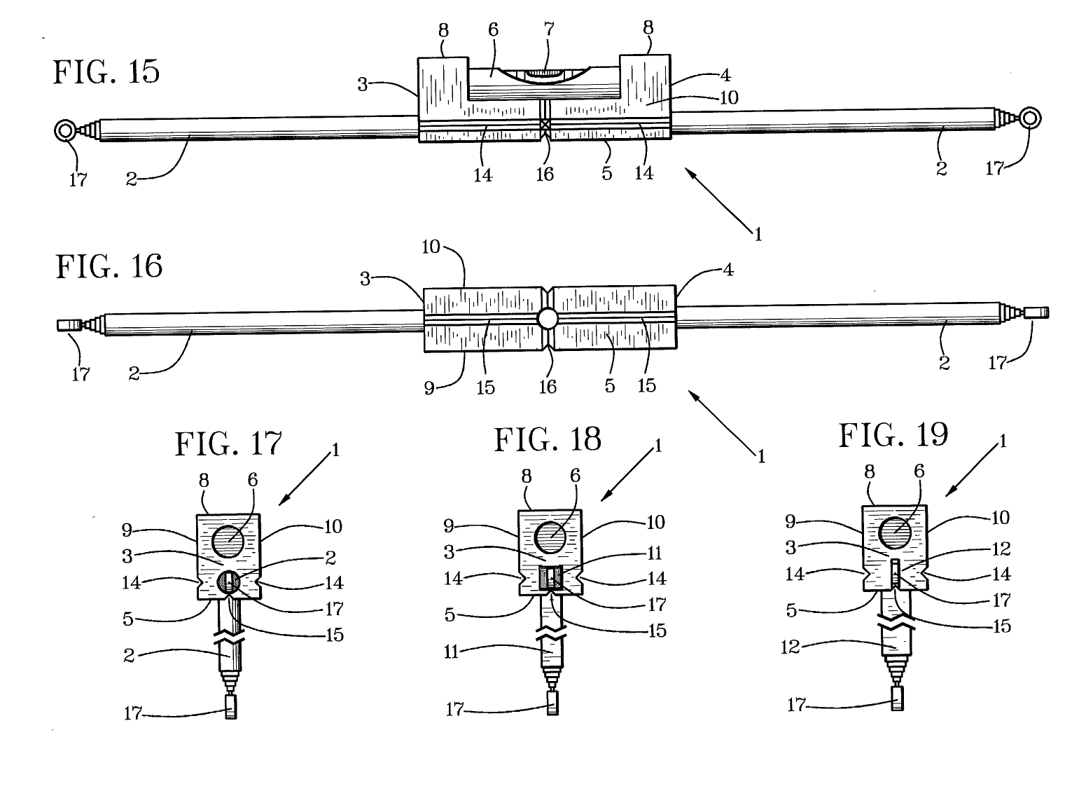

Referring to FIGS. 1-19 and in particular to FIGS. 15-19, the bottom 5 preferably includes a bottom horizontal-surface wall and the top 8 includes a top horizontal-surface wall, both of which are rectangular intermediate the first end 3 and the second end 4 of the bubble-level block 1. The first side 9 includes a vertical side wall and the second side 10 includes a vertical side wall of the bubble-level block 1, both of which are rectangular. The first end 3 includes a vertical end wall and the second end 4 includes vertical end wall, both of which are rectangular. The bubble-level block 1 has a finger-holdable width intermediate the first vertical side wall and the second vertical side wall, a finger-holdable length intermediate the first vertical end wall and the second vertical end wall and a finger-holdable height intermediate the bottom horizontal-surface wall and the top horizontal-surface wall. The finger-holdable width is approximately three-fourths of an inch; the finger-holdable length is approximately three inches and the finger-holdable height is approximately one inch.

The bubble-level block 1 includes the leveling bubble 7 in the level-bubble tube 6 that is parallel to the bottom horizontal-surface wall of the bubble-level block 1, parallel to the horizontal axes of the telescopic markers and perpendicular to the vertical end walls of the bubble-level block 1. The level-bubble tube 6 is situated intermediate the first end 3 and the second end 4. The level-bubble tube 6 has a tube axis that is parallel to the bottom horizontal-surface wall. The first vertical side wall and the second vertical side wall include side-vision bays predeterminedly intermediate the first end 3 and the second end 4 for side vision of the leveling bubble 7. As seen from a top view, the top horizontal wall includes a top vision bay predeterminedly intermediate the first end 3 and the second end 4 of the bubble-level block 1 for top vision of the leveling bubble 7. The level-bubble tube 6 is situated predeterminedly lower vertically than the top horizontal wall.

The first vertical side wall and the second vertical side wall include side positioning channels 14 that are parallel to the bottom horizontal-surface wall and coplanar to a horizontal marker axis of a telescopic marker extended from an end of the bubble-level block 1. The side positioning channels 14 are preferably V-shaped as shown.

The bottom horizontal-surface wall includes a bottom positioning channel 15 that is parallel to the first vertical side wall, parallel to the second vertical side wall and coplanar to the horizontal marker axes of one or more of the telescopic markers 2, 11 or 12 that are extended from the ends of the bubble-level block 1. The bottom positioning channel 15 is preferably V-shaped. Cross positioning channels 16 also can be included.

The side positioning channels 14, the bottom positioning channels 15 and the cross positioning channels 16 are particularly useful for resting the bubble-level block 1 on edge corners of some picture frames for leveling them in relation to others and for marking walls.

Referring to FIGS. 20-26 particularly and to FIGS. 1-26 generally, marking aids are included on extendable ends of the telescopic markers 2, 11 and 12. As shown in FIGS. 1-19, the marking aids can include a marker ring 17 that is articulated to be a general-purpose marking aid having a circumferential wall attached to the extendable end of the telescopic marker for positioning of a pencil or other marking device centrally in the marker ring 17 and coplanar to the axis of the telescopic marker. Although intended for general-purpose use, the marker ring 17 can be sized and shaped for a specific marking instrument or class of marking instruments.

As shown in FIG. 20, the marking aid can include a point holder 18 that is articulated to cinch-hold a marker point that includes a pencil lead, a stylus and a needle-like metallic point.

As shown in FIG. 21, the marking aid can include a liquid-dispenser holder 19 that is articulated to hold a liquid-dispenser that includes a ball-point pen.

As shown in FIG. 22, the marking aid can include a powder holder 20 that is articulated to hold a porous dispenser of powder.

As shown in FIG. 23, the marking aid can include a marking point 21 that is attachable directly to the extendable end of the telescopic marker.

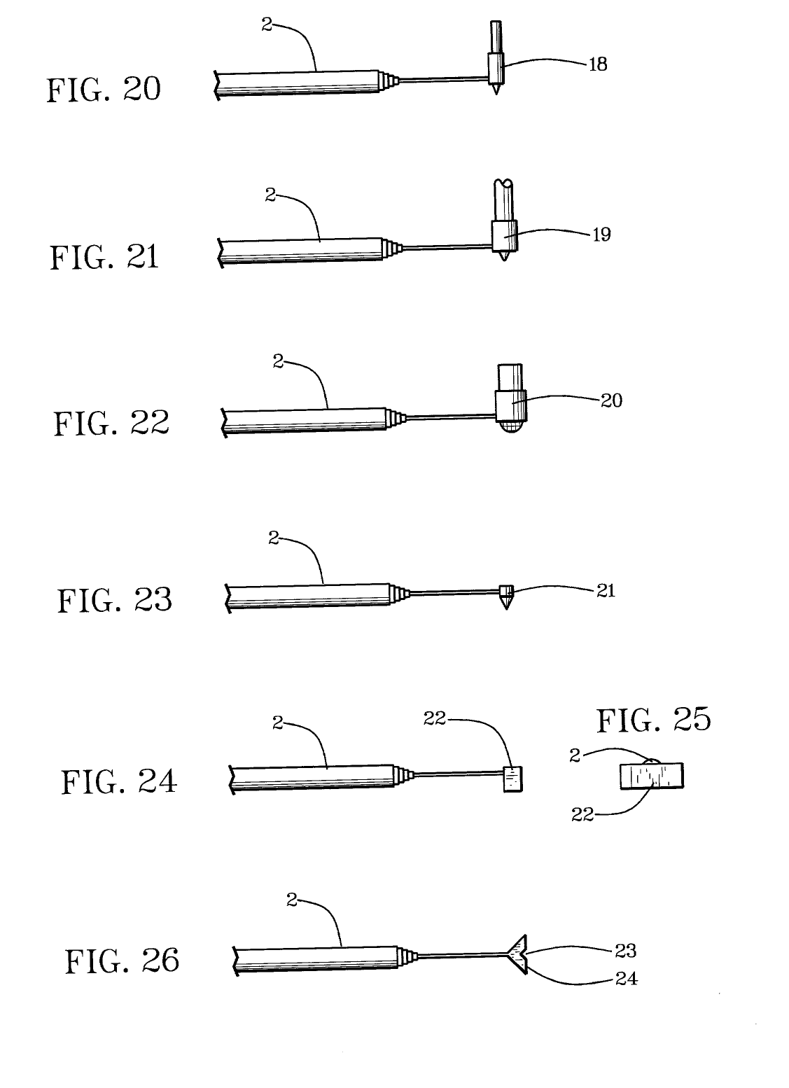

As shown in FIGS. 24-25, the marking aid can include a straight-edge block 22 that is rectangular and predeterminedly short with walls that are parallel to at least the bottom horizontal-surface wall, the first vertical-surface wall and the second vertical-surface wall of the bubble-level block 1.

As shown in FIG. 23, the marking aid can include a V-shaped indentation 23 having an axis that is collinear to the axis of the telescopic marker and can be in a straight edge 24 that is perpendicular to the telescopic marker.

A new and useful telescopic leveling instrument having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A telescopic leveling instrument comprising:
a bubble-level block having orthogonal walls;
one or more telescopic markers extended horizontally from at least one vertical wall of the orthogonal walls of the bubble-level block; and
the bubble-level block being small, light-weight and articulated to be hand-held with a first hand of a user for positioning it against an object while with a second hand of the user, the telescopic markers are employed to measure and to mark selectively in relationship to the object.

2. The telescopic leveling instrument of claim 1 wherein:
the telescopic markers are extended from two oppositely disposed vertical walls of the bubble-level block and have horizontal axes that are collinear.

3. The telescopic leveling instrument of claim 2 and further comprising:
a telescopic marker extended vertically from a bottom wall of the bubble-level block and having a vertical axis that is orthogonal to the horizontal axes of the telescopic markers that are extended from the two oppositely disposed vertical walls.

4. The telescopic leveling instrument of claim 1 and further comprising:
a level-bubble tube on the bubble-level block;
the level-bubble tube having a leveling bubble that is exposed for visibility from a top of the bubble-level block; and
the level-bubble tube being parallel to the bottom wall of the bubble-level block, parallel to the horizontal axes of the telescopic markers and perpendicular to the vertical walls of the bubble-level block.

5. The telescopic leveling instrument of claim 1 wherein:
the leveling bubble is exposed for visibility from at least part of sides of the bubble-level block.

6. The telescopic leveling instrument of claim 1 wherein:
the telescopic markers are articulated to provide marking rigidity to maintain an extended-mode horizontality to the bottom horizontal-surface wall.

7. The telescopic leveling instrument of claim 1 wherein:
the telescopic markers are articulated to provide horizontal-bend resilience for touch marking with marking aids on the extendable ends.

8. The telescopic leveling instrument of claim 1 wherein:
the telescopic markers include a plurality of circular telescopic tubes having outside circular telescopic tubes affixed to the bubble-level block and successively inside circular telescopic tubes slidable axially outward and inward selectively in telescopic working relationship.

9. The telescopic leveling instrument of claim 1 wherein:
the telescopic markers include a plurality of square telescopic tubes having outside square telescopic tubes affixed to the bubble-level block and successively inside square telescopic tubes slidable axially outward and inward selectively in telescopic working relationship.

10. The telescopic leveling instrument of claim 1 wherein:
the telescopic markers include a plurality of vertically oriented rectangular telescopic tubes having outside vertically oriented rectangular telescopic tubes affixed to the bubble-level block and successively inside vertically oriented rectangular telescopic tubes slidable axially outward and inward selectively in telescopic working relationship

11. A telescopic leveling instrument comprising:
a bubble-level block having orthogonal walls which are predeterminedly rectangular;
the orthogonal walls including a first end, a second end, a bottom, a top, a first side and a second side;
the first end including a first vertical end wall and the second end including a second vertical end wall;
the first side including a first vertical side wall and the second side including a second vertical side wall;
the bottom including a bottom horizontal-surface wall and the top including a top horizontal-surface wall;
one or more telescopic markers extended horizontally from at least one of the vertical end walls;
marking aids on extendable ends of at least one of the telescopic markers; and
the bubble-level block being small, light-weight and articulated to be hand-held with a first hand of a user for positioning it against an object while with a second hand of the user, the telescopic markers are employed to measure and to mark selectively in relationship to the object.

12. The telescopic leveling instrument of claim 11 wherein:
the telescopic markers include a first telescopic marker extended from the first end and a second telescopic marker extended from the second end of the bubble-level block;
the bubble-level block has a block axis intermediate the first end and the second end thereof;
the block axis is parallel to the bottom, the top, the first side and the second side of the bubble-level block;
the first telescopic marker and the second telescopic marker have horizontal marker axes that are collinear; and
the horizontal marker axes are parallel to the block axis.

13. The telescopic leveling instrument of claim 12 and further comprising:
a bottom telescopic marker extended perpendicularly from a plane of the bottom of the bubble-level block and having a vertical axis that is orthogonal to the horizontal marker axes.

14. The telescopic leveling instrument of claim 11 and further comprising:
a level-bubble tube on the bubble-level block;
the level-bubble tube having a leveling bubble that is exposed for visibility from a top of the bubble-level block; and
the level-bubble tube being parallel to the bottom wall of the bubble-level block, parallel to the horizontal axes of the telescopic markers and perpendicular to the vertical end walls of the bubble-level block.

15. The telescopic leveling instrument of claim 11 wherein:
the leveling bubble is exposed for visibility from at least part of sides of the bubble-level block.

16. The telescopic leveling instrument of claim 11 wherein:
the telescopic markers are attached removably to allow attachment of a single telescopic marker to the bubble-level block.

17. The telescopic leveling instrument of claim 11 wherein:
the telescopic markers are ruled with distance indicia from a predetermined point on the bubble-level block to predetermined points proximate the extendable ends of the telescopic markers.

18. The telescopic leveling instrument of claim 11 wherein:
the bottom horizontal-surface wall and the top horizontal-surface wall are rectangular intermediate the first end and the second end of the bubble-level block are rectangular;
the first vertical side wall and the second vertical side wall of the bubble-level block are rectangular; and
the first vertical end wall and the second vertical end wall of the bubble-level block are rectangular.

19. The telescopic leveling instrument of claim 18 wherein:
the bubble-level block has a finger-holdable width intermediate the first vertical side wall and the second vertical side wall;
the bubble-level block has a finger-holdable length intermediate the first vertical end wall and the second vertical end wall; and
the bubble-level block has a finger-holdable height intermediate the bottom horizontal-surface wall and the top horizontal-surface wall.

20. The telescopic leveling instrument of claim 19 wherein:
the finger-holdable width is approximately three-fourths of an inch;
the finger-holdable length is approximately three inches and
the finger-holdable height is approximately one inch.

21. The telescopic leveling instrument of claim 19 wherein:
the bubble-level block includes a leveling bubble in a level-bubble tube that is parallel to the bottom horizontal-surface wall of the bubble-level block, parallel to the horizontal axes of the telescopic markers and perpendicular to the vertical end walls of the bubble-level block;
the level-bubble tube is situated intermediate the first end and the second end of the bubble-level block;
the level-bubble tube has a tube axis that is parallel to the bottom horizontal-surface wall;
the first vertical side wall and the second vertical side wall include side-vision bays predeterminedly intermediate the first end and the second end of the bubble-level block for side vision of the leveling bubble;
the top horizontal wall includes a top vision bay predeterminedly intermediate the first end and the second end of the bubble-level block for top vision of the leveling bubble; and
the level-bubble tube is situated predeterminedly lower vertically than the top horizontal wall.

22. The telescopic leveling instrument of claim 21 wherein:
the first vertical side wall and the second vertical side wall include side positioning channels that are parallel to the bottom horizontal-surface wall and coplanar to a horizontal marker axis of a telescopic marker extended from an end of the bubble-level block.

23. The telescopic leveling instrument of claim 22 wherein:
the side positioning channels are V-shaped.

24. The telescopic leveling instrument of claim 21 wherein:
the bottom horizontal-surface wall includes a bottom positioning channel that is parallel to the first vertical side wall, parallel to the second vertical side wall and coplanar to the horizontal marker axis of the telescopic marker extended from the end of the bubble-level block.

25. The telescopic leveling instrument of claim 24 wherein:
the bottom positioning channel is V-shaped.

26. The telescopic leveling instrument of claim 11 wherein:
the marking aid is attached removably to the extendable ends of the telescopic markers.

27. The telescopic leveling instrument of claim 11 wherein:
the marking aid includes a marker ring having a circumferential wall attached to the extendable end of the telescopic marker for positioning of a pencil or other marking device centrally in the marker ring and coplanar to the axis of the telescopic marker.

28. The telescopic leveling instrument of claim 11 wherein:
the marking aid includes a point holder that is articulated to cinch-hold a marker point that includes a pencil lead and a needle-like metallic point.

29. The telescopic leveling instrument of claim 11 wherein:
the marking aid includes a liquid-dispenser holder that is articulated to hold a liquid-dispenser that includes a ball-point pen.

30. The telescopic leveling instrument of claim 11 wherein:
the marking aid includes a powder holder that is articulated to hold a porous dispenser of powder.

31. The telescopic leveling instrument of claim 11 wherein:
the marking aid includes a marking point that is attachable directly to the extendable end of the telescopic marker.

32. The telescopic leveling instrument of claim 11 wherein:
the marking aid includes a straight-edge block;

33. The telescopic leveling instrument of claim 32 wherein:
the straight-edge block is rectangular with walls that are parallel to at least the bottom horizontal-surface wall, the first vertical-surface wall and the second vertical-surface wall of the bubble-level block.

34. The telescopic leveling instrument of claim 11 wherein:
the marking aid includes a V-shaped indentation having an axis that is collinear to the axis of the telescopic marker.

35. The telescopic leveling instrument of claim 11 wherein:
the telescopic markers are articulated to provide marking rigidity to maintain an extended-mode horizontality to the bottom horizontal-surface wall.

36. The telescopic leveling instrument of claim 11 wherein:
the telescopic markers are articulated to provide horizontal-bend resilience for touch marking with marking aids on the extendable ends.

37. The telescopic leveling instrument of claim 11 wherein:
the telescopic markers include a plurality of circular telescopic tubes having outside circular telescopic tubes affixed to the bubble-level block and successively inside circular telescopic tubes slidable axially outward and inward selectively in telescopic working relationship.

38. The telescopic leveling instrument of claim 11 wherein:
the telescopic markers include a plurality of square telescopic tubes having outside square telescopic tubes affixed to the bubble-level block and successively inside square telescopic tubes slidable axially outward and inward selectively in telescopic working relationship.

39. The telescopic leveling instrument of claim 11 wherein:
the telescopic markers include a plurality of vertically oriented rectangular telescopic tubes having outside vertically oriented rectangular telescopic tubes affixed to the bubble-level block and successively inside vertically oriented rectangular telescopic tubes slidable axially outward and inward selectively in telescopic working relationship

40. A telescopic leveling instrument comprising:
a bubble-level block having orthogonal walls which are predeterminedly rectangular;
the orthogonal walls including a first end, a second end, a bottom, a top, a first side and a second side;
the first end including a first vertical end wall and the second end including a second vertical end wall;
the first side including a first vertical side wall and the second side including a second vertical side wall;
the bottom including a bottom horizontal-surface wall and the top including a top horizontal-surface wall;
one or more telescopic markers extended horizontally from at least one of the vertical end walls;
marking aids on extendable ends of at least one of the telescopic markers;
the telescopic markers include a first telescopic marker extended from the first end and a second telescopic marker extended from the second end of the bubble-level block;
the bubble-level block being small, light-weight and articulated to be hand-held with a first hand of a user for positioning it against an object while with a second hand of the user, the telescopic markers are employed to measure and to mark selectively in relationship to the object;
the bubble-level block has a block axis intermediate the first end and the second end thereof;
the block axis is parallel to the bottom, the top, the first side and the second side of the bubble-level block;
the first telescopic marker and the second telescopic marker have horizontal marker axes that are collinear;
the horizontal marker axes are parallel to the block axis;
a bottom telescopic marker extended perpendicularly from a plane of the bottom of the bubble-level block and having a vertical axis that is orthogonal to the horizontal marker axes;
the telescopic markers are attached removably to allow attachment of a single telescopic marker to the bubble-level block;
a level-bubble tube on the bubble-level block;
the level-bubble tube having a leveling bubble that is exposed for visibility from a top of the bubble-level block;
the level-bubble tube being parallel to the bottom wall of the bubble-level block, parallel to the horizontal axes of the telescopic markers and perpendicular to the vertical end walls of the bubble-level block;
the leveling bubble is exposed for visibility from at least part of sides of the bubble-level block;
the bottom horizontal-surface wall and the top horizontal-surface wall are rectangular intermediate the first end and the second end of the bubble-level block;
the first vertical side wall and the second vertical side wall of the bubble-level block are rectangular;
the first vertical end wall and the second vertical end wall of the bubble-level block are rectangular;
the bubble-level block has a finger-holdable width intermediate the first vertical side wall and the second vertical side wall;
the bubble-level block has a finger-holdable length intermediate the first vertical end wall and the second vertical end wall;
the bubble-level block has a finger-holdable height intermediate the bottom horizontal-surface wall and the top horizontal-surface wall;
the bubble-level block includes a leveling bubble in a level-bubble tube that is parallel to the bottom horizontal-surface wall of the bubble-level block, parallel to the horizontal axes of the telescopic markers and perpendicular to the vertical end walls of the bubble-level block;
the level-bubble tube is situated intermediate the first end and the second end of the bubble-level block;
the level-bubble tube has a tube axis that is parallel to the bottom horizontal-surface wall;
the first vertical side wall and the second vertical side wall include side-vision bays predeterminedly intermediate the first end and the second end of the bubble-level block for side vision of the leveling bubble;
the top horizontal wall includes a top vision bay predeterminedly intermediate the first end and the second end of the bubble-level block for top vision of the leveling bubble; and
the level-bubble tube is situated predeterminedly lower vertically than the top horizontal wall.

41. The telescopic leveling instrument of claim 40 wherein:
the telescopic markers are ruled with distance indicia from a predetermined point on the bubble-level block to predetermined points proximate the extendable ends of the telescopic markers.

42. The telescopic leveling instrument of claim 40 wherein:
the first vertical side wall and the second vertical side wall include side positioning channels that are parallel to the bottom horizontal-surface wall and coplanar to a horizontal marker axis of a telescopic marker extended from an end of the bubble-level block.

43. The telescopic leveling instrument of claim 40 wherein:
the bottom horizontal-surface wall includes a bottom positioning channel that is parallel to the first vertical side wall, parallel to the second vertical side wall and coplanar to the horizontal marker axis of the telescopic marker extended from the end of the bubble-level block.

44. The telescopic leveling instrument of claim 40 wherein:
the marking aid is includes a selection of marking aids that are attached removably to the extendable ends of the telescopic markers.

45. The telescopic leveling instrument of claim 40 wherein:
the telescopic markers are articulated to provide marking rigidity to maintain an extended-mode horizontality to the bottom horizontal-surface wall.

46. The telescopic leveling instrument of claim 40 wherein:
the telescopic markers are articulated to provide horizontal-bend resilience for touch marking with marking aids on the extendable ends.

47. The telescopic leveling instrument of claim 40 wherein:
the telescopic markers include a plurality of circular telescopic tubes having outside circular telescopic tubes affixed to the bubble-level block and successively inside circular telescopic tubes slidable axially outward and inward selectively in telescopic working relationship.

48. The telescopic leveling instrument of claim 40 wherein:
the telescopic markers include a plurality of square telescopic tubes having outside square telescopic tubes affixed to the bubble-level block and successively inside square telescopic tubes slidable axially outward and inward selectively in telescopic working relationship.

49. The telescopic leveling instrument of claim 40 wherein:
the telescopic markers include a plurality of vertically oriented rectangular tubes having outside vertically oriented rectangular tubes affixed to the bubble-level block and successively inside vertically oriented rectangular tubes slidable axially outward and inward selectively in telescopic working relationship.
